(19) United States
(12) Patent Application Publication
(10) Pub. No.: US 2006/0077679 A1
(43) Pub. Date: Apr. 13, 2006

(54) Emergency reflective device for vehicles

(76) Inventor: William D. McAnally, Stouffville (CA)

Correspondence Address: GEORGE A. ROLSTON, 45 SHEPPARD AVE EAST, SUITE 900, TORONTO, ON, M2N5W9, CA

(21) Appl. No.: 11/169,004

(22) Filed: Jun. 29, 2005

Related U.S. Application Data
(60) Provisional application No. 60/616,619, filed on Oct. 8, 2004.

(51) Int. Cl. B60Q 1/56; B60Q 1/26

(52) U.S. Cl. 362/497; 362/516; 362/540

(57) ABSTRACT

A light reflector device for application to a vehicle having a temporary flexible reflective panel with a light reflective material and having a front and a reverse side, adhesive material on the reverse side and a peelable backing sheet releasably bonded to the adhesive.

### FIELD OF THE INVENTION

The invention relates to a light reflector device for vehicles and in particular to an emergency reflective device for temporarily covering a defective headlight with a reflective panel.

### BACKGROUND OF THE INVENTION

The use of vehicle headlights both by day and by night has two functions. Obviously, the lights assist the driver of the vehicle primarily when driving at night or in shaded locations such as bridges, tunnels and the like.

Another important aspect of the use of headlights is that they assist oncoming drivers and other road users such as pedestrians in locating an oncoming vehicle both at night and by day. The primary function of headlights is obviously to enable the driver to see where he is going at night. However, the headlights of a vehicle also perform other useful functions in that they assist simply as a warning that a vehicle is approaching by night or by day. Headlights also as a means of judging speed of the approaching vehicle, and in many cases, and its location. The spacing of the lights to some extent enable a person to judge the speed of an approaching vehicle.

Most vehicles have two headlights spaced apart on either side of the front of the vehicle. As in the case of any electrical device, headlights may fail. Bulbs may burn out. Wiring may break. A light may be damaged in a minor collision.

In any of these cases, the vehicle is then left with only one light, or in extreme cases, with none at all. If this happens, then where there is only one light which is lit, a pedestrian, or the driver of another oncoming vehicle may have no way of judging the width of the vehicle with the defective light. He may misjudge the location of the defective vehicle on the road and a collision results. Other mishaps may occur as will be apparent to the reader.

Where both headlights fail the situation is even more hazardous. Even if the street lights in the location of the vehicle are sufficient to enable the driver to drive slowly and cautiously to a place of safety, or where he can obtain assistance, the mere presence of an unlit moving vehicle will create great danger for other road users and pedestrians as well.

Often it is not possible for the driver of the defective vehicle to have the light repaired immediately. He may have to drive many miles, especially at night, before finding a service station where the problem can be repaired. The danger will exist as long as he drives the defective vehicle.

It is clearly desirable to have some form of temporary device which can help the driver travel at least some distance to reduce the danger of collision. Ideally, vehicles would be equipped with a portable light which could somehow be fastened in place of the defective light. However, so far such solutions have been impractical.

In other situations, it is desirable to provide some light for an additional alerting device, or for reflecting light on various parts of a vehicle, or conceivably, for use on objects other than vehicles.

### BRIEF SUMMARY OF THE INVENTION

With a view to answering at least some of the foregoing problems, the invention provides a light reflector device for a vehicle for temporary application, such as in an emergency, to a location such as a defective headlight or being placeable at or close to the location of the defective light, and having a flexible mountable panel having a light reflective material and defining a front side and a reverse side, adhesive material on the reverse side of the flexible mountable panel, a backing sheet releasably bonded to the adhesive material; and, indicia defining fold lines on the outward face of the backing sheet.

Preferably the backing sheet will have fold lines marked on it. By peeling marginal parts of the backing sheet back along the fold lines, sufficient adhesive can be exposed to secure the flexible mountable panel temporarily to a location on the vehicle.

However, by leaving the backing sheet still adhering to the flexible mountable panel in central intermediate areas, it is easier to remove the flexible mountable panel when the driver is able to reach a service location and repair the vehicle.

The flexible mountable panel may be rectangular, round, oval or any other suitable shape. The backing sheet may usually be rectangular. The fold lines and other indicia will be printed on the reverse side of the backing sheet.

The various features of novelty which characterize the invention are pointed out with more particularity in the claims annexed to and forming a part of this disclosure. For a better understanding of the invention, its operating advantages and specific objects attained by its use, reference should be made to the accompanying drawings and descriptive matter in which there are illustrated and described preferred embodiments of the invention.

### IN THE DRAWINGS

FIG. 1 is a schematic perspective of a vehicle with the light reflector device secured on the front, just below the location of a defective headlight;

FIG. 2 is a rear elevation of a light reflector device illustrating the invention;

FIG. 3 is a top plan of the light reflector device ready for application, in a second position;

FIG. 4 is a top plan view showing the reflector applied on a location on a vehicle;

FIG. 5 is a top plan of an alternate embodiment;

FIG. 6 is a rear elevation of an alternate embodiment;

FIG. 7 is a plan view of a modified form of translucent reflective panel showing alternate strips of particles; and,

FIG. 8 is a section of the translucent panel of FIG. 7 along line 8-8, showing light reflective particles embedded therein.

### DESCRIPTION OF A SPECIFIC EMBODIMENT

As explained above, the invention is intended to assist by providing an application of a temporary reflective patch or safety device for a location on a vehicle, such as a defective headlight. It is not intended to provide additional or replacement light to the actual light from a missing headlight. The driver of the defective vehicle will have to drive with more caution since his vehicle will have one less light.

However, where the light reflector device of the invention is used, drivers of other vehicles, pedestrians and other road users will have more warning of the defective condition, and will be better able to judge the location, direction and speed of the defective vehicle.

The invention is also intended to provide such temporary safety device at a reasonable cost. Drivers may buy one in advance of any problem and store it in case a problem arises. It will also be simple to use and have a long storage life.

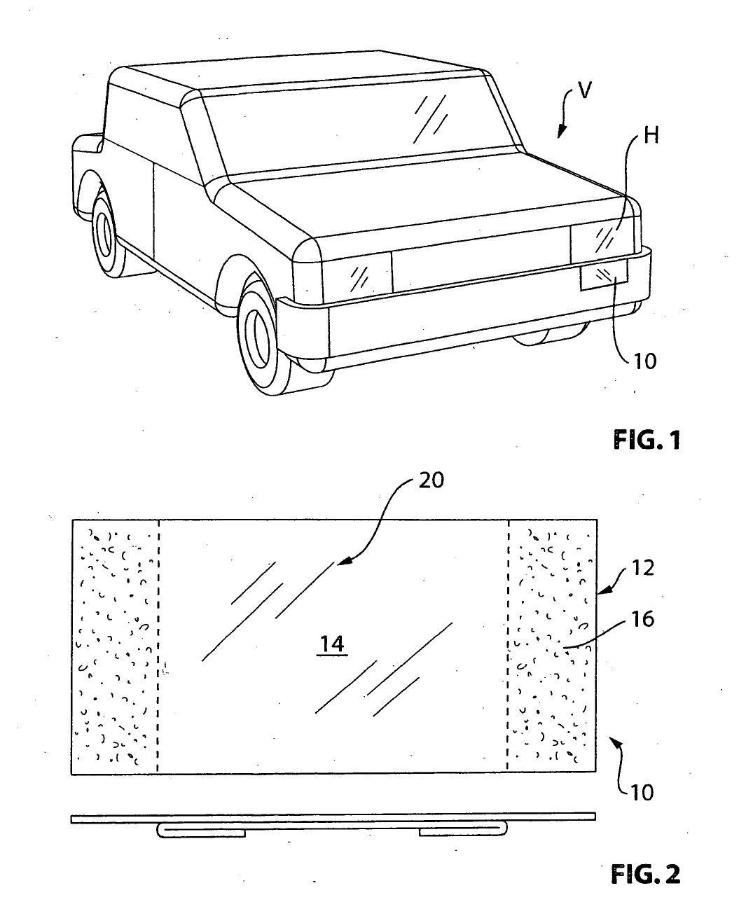

FIG. 1 shows a typical situation of a vehicle V with its left headlight H defective. A light reflector device 10 has been applied to the vehicle just below the location of the light. With these observations in mind, reference will be made to FIGS. 2 to 4. The light reflector device comprises, in this embodiment, a reflective panel 12 and a backing sheet 14, which are bonded together by any known form of separatable or peelable adhesive 16. Typically, such adhesive will be applied to the reverse side of reflective panel 12. Backing sheet 14 will usually be of some adhesive resistant material, such as wax paper although many types of such adhesive resistant material are well known. The panel 12 and backing sheet 14 thus form a so-called “peel and stick” system. Such systems are in wide use for address labels, courier label envelopes, mailing envelopes and postage stamps to name only a few common every day instances. Reflective panel 12 in this embodiment is formed of sheet thermoplastic material, preferably translucent material, in which there are embedded or otherwise present a large number of small light reflective particles 18. Such particles 18 have the property of reflecting incident light and reflect it in a random scattered fashion. The panel 12 is preferably translucent, or in some cases transparent, so that incidental light falling on it from the headlights of an oncoming vehicle or from street lighting or any available lighting source, may be reflected by the particles 18 so as to give off a glow. This will act as effective warning to other road users that a vehicle is approaching, which has at least visible spacing or width between the sound headlight and the defective headlight. In this way, such other road users may have sufficient warning of the location, speed and direction of the vehicle so as to take appropriate action to avoid it.

The backing sheet 14 may be formed with indicia 20, which may be directions for use and with other indicia in the form of fold lines 22-22 printed on its reverse outward face (FIG. 2). Lines 22-22 define two side portions 24-24 and a median portion 26. Instructions may also printed on backing sheet 14 or may, in some cases, be printed on a separate instruction sheet for greater assistance to the user. The instructions will tell the user to partially peel away the two side portions 24-24, but leave the median portion 26 adhered to the reflective panel 12.

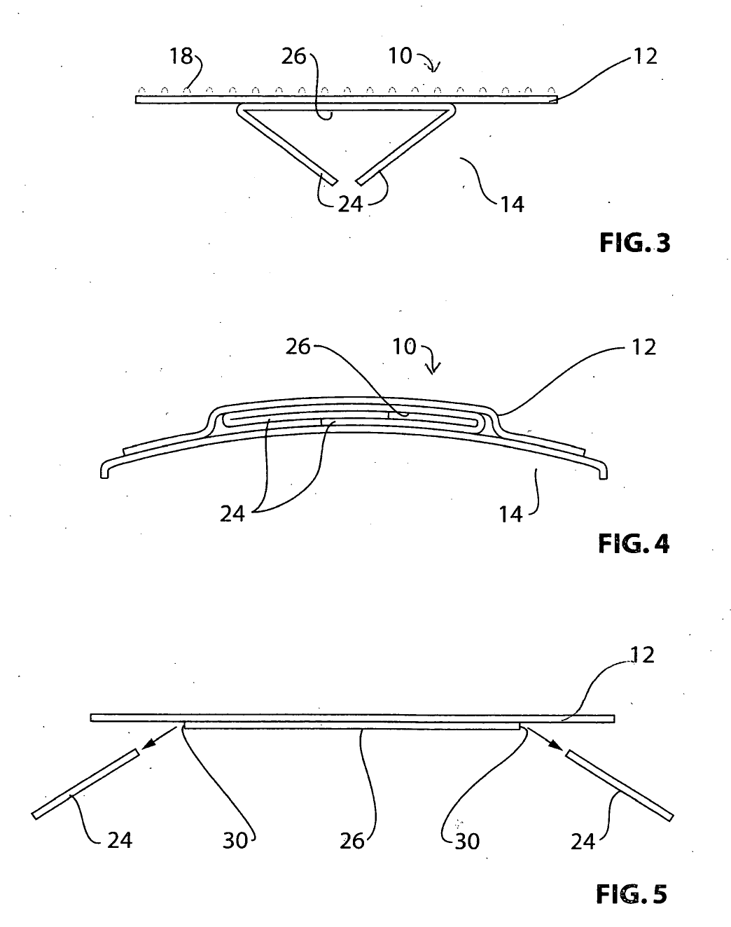

Fold lines 22-22 indicate the extent to which such side portions 24-24 should be peeled back. The two-side portions 24-24 are then folded inwards along lines 22-22 over the median portion 26 (FIG. 3). This will then form a combined thickness of three thicknesses of panel, namely the two side portions 24-24 and the median portion 26, extending down the centre of the rearward side of reflective panel 12.

The reflective panel 12 may then placed over the headlight H or may be placed on the vehicle along side the headlight or other defective device in the preferred method (FIG. 4). The two exposed patches of adhesive 16 on the side segments of the panel 12 will then adhere to the vehicle.

The rest or median portion of the panel 12, which remains bonded to the median portion 26 of backing sheet 14, will not become bonded to the vehicle but will be held spaced from it by the two folded side portions 24-24 and the median portion 26. The purpose of this is to facilitate the removal of the light reflector device 10 when the owner reaches a service station and can have the problem corrected. At this point, all he has to do is to grasp the top edge of the median portion 26 of backing sheet 14, and pull it away from the vehicle.

This will strip the adhesive 16 on the side portions of reflective panel 12 away from the vehicle. The headlight or other device can then be repaired and the light reflector device 10.

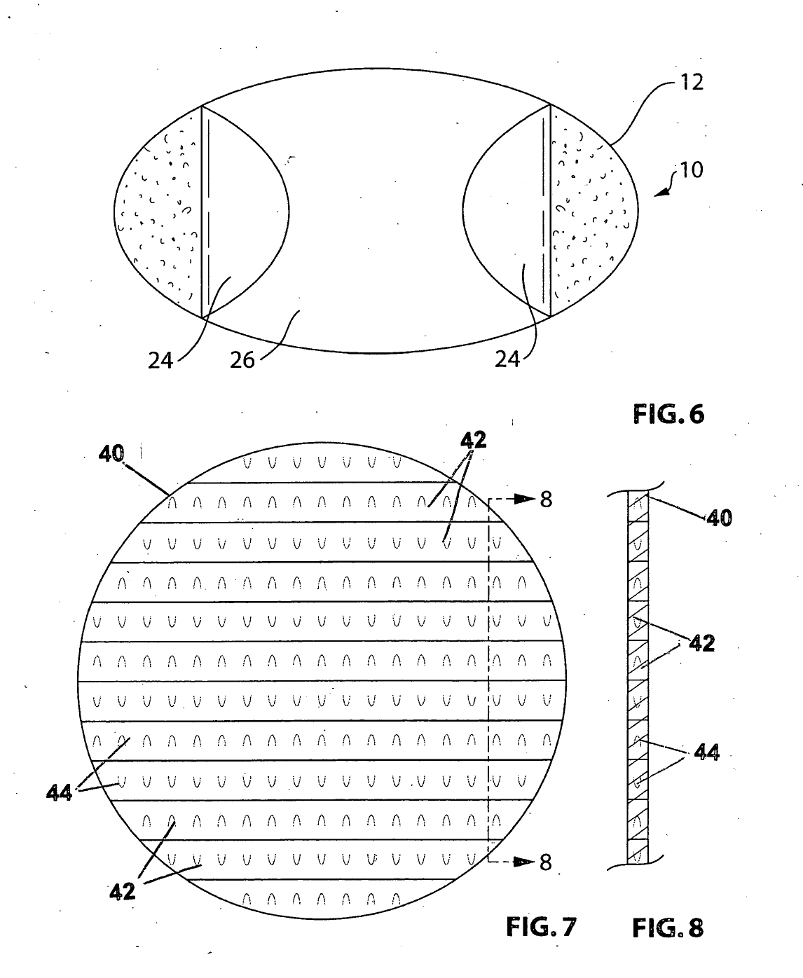

An alternate embodiment is shown in FIG. 5. In this case, the reflective panel 12 has a backing sheet 14 which may be formed with two tear lines 30-30, defining side portions 24-24 and a median portion 26. In use, the two side portions 24-24 are peeled away from reflective panel 10 and are torn away from median portion 26 by tearing along lines 30-30. The reflective panel 12 is then adhered along either side segment to the vehicle as described above. In this case, the median portion 26 remains adhered to the panel 12, preventing the median portion of the panel 12 from bonding to the vehicle. Various shapes can be given to the reflective panel 12. FIG. 6 shows such a reflective panel 12 which is oval. This may be more suitable for some designs of vehicle where the existing headlights are already of a generally oval shape. Such an oval reflective panel 12 may provide a better simulation of a set of headlights than another shape. However, the precise shape may vary from one application to another. As shown, the backing sheet 14 is usually rectangular. This facilitates manufacture and also facilitates peeling away portions from the reflective panel in the manner described.

It will, of course, be appreciated that there will be some users who fail to read the instruction or who simply prefer to peel away the entire backing sheet 14. This will enable the reflective panel to be bonded over its entire area. Removal of the reflective panel may be rendered more difficult in this case. On the other hand, such a more permanent application may be desirable for some uses. For example, the reflective panel may be used on slow moving vehicles, construction equipment, farm vehicles, and the like in order to provide a greater degree of all round alerting devices for warning other road users of the hazard of a slow moving vehicle.

The material of panel 12 is a synthetic material and is formed with particles of a highly reflective material 40, (FIG. 7) embedded therein.

Preferably, the particles are arranged in parallel strips 42 and 44, extending across the material. The particles 40 in these strips are oriented in such a way that, for example, the particles 40 in strips 42 will reflect light to either side, while the particles 40 in strips 44 will reflect light upwardly and downwardly.

This is advantageous in that it provides a distinctive flash of light to persons viewing the oncoming vehicle. As the vehicle rides over the, usually uneven, road surface, the separate strips 42 and 44 will create a simulated flashing effect, which will catch the eye of the person and act as a warning of the approach of the vehicle.

Preferably the reflective material 40 will be of sufficient concentration in the panel that it can create a momentary reflection equal to about 700 to 800 candle power.

The foregoing is a description of a preferred embodiment of the invention which is given here by way of example only. The invention is not to be taken as limited to any of the specific features as described, but comprehends all such variations thereof as come within the scope of the appended claims.

What is claimed is:

1. A light reflector device for application to a vehicle and comprising;
a temporary flexible reflective panel of synthetic material and defining a front and a reverse side;
light reflective material particles embedded in said reflective panel;
adhesive material on said reverse side of said reflective panel; and
a peelable backing panel releasably bonded to said adhesive material.

2. A light reflector device for application to a vehicle as claimed in claim 1 wherein the backing panel has forward and rearward surfaces, and indicia printed on the rearward surface of said backing panel.

3. A light reflector device for application to a vehicle as claimed in claim 2 and wherein said indicia are fold lines parallel and spaced apart and defining two side portions and a median portion therebetween of said backing panel.

4. A light reflector device for application to a vehicle as claimed in claim 1 wherein said reflective panel comprises a panel of synthetic translucent sheet material and light reflective material particles embedded in said translucent sheet material, and wherein said particles are arranged in pairs of parallel strips adjacent to one another, with particles in one of said strips in each said pair being oriented to reflect light in at least one first predetermined direction,
and with particles in another of said strips in said pairs be oriented to reflect light in a second predetermined direction different from said first direction.

5. A light reflector device for application to a vehicle and comprising;
a temporary flexible reflective translucent panel of synthetic material and defining a front and a reverse side;
light reflective material particles embedded in said reflective panel;
adhesive material on said reverse side of said reflective panel; and
a peelable backing panel releasably bonded to said adhesive material.
wherein said light reflective material particles embedded in said translucent panel, and
wherein said particles are arranged in pairs of parallel strips adjacent to one another, with particles in one of said strips in each said pair being oriented to reflect light in at least one first predetermined direction,
and with particles in another of said strips in said pairs be oriented to reflect light in a second predetermined direction different from said first direction.
